(19) United States
(12) Patent Application Publication
(10) Pub. No.: US 2026/0167757 A1
(43) Pub. Date: Jun. 18, 2026

(54) IONIC POLYMERS USED AS CORROSION INHIBITORS IN PROCESS STREAMS IN INDUSTRIAL SYSTEMS AND THEIR METHOD OF OBTAINING

(71) Applicant: Instituto Mexicano del Petróleo, Mexico City (MX)

(72) Inventors: Diego Javier Guzmán Lucero, Mexico City (MX); Mercedes Bazaldua Domínguez, Mexico City (MX); Araceli Vega Paz, Mexico City (MX); Natalya Victorovna Likhanova, Mexico City (MX)

(21) Appl. No.: 19/404,621

(22) Filed: Dec. 1, 2025

(30) Foreign Application Priority Data
Dec. 13, 2024 (MX) MX/A/2024/015525

(51) Int. Cl. C08F 226/10; C08F 8/36; C08F 220/56; C08F 290/06; C23F 11/173

(52) U.S. Cl. CPC C08F 226/10; C08F 8/36; C08F 220/56; C08F 290/062; C23F 11/173

(57) ABSTRACT

The present disclosure relates to ionic copolymers and terpolymers derived from monomers such as 1-alkyl-3-vinylimidazolium halides, 1-vinylimidazole, acrylamide, n-vinylpyrrolidone, and poly(ethylene glycol) methyl ether methacrylate, and their use as corrosion inhibitors in process streams in industrial systems, more specifically in oil refinery streams. The corrosion inhibitors function at concentrations below 100 ppm, temperatures up to 60° C., and in the presence of congenital waters or synthetic brines.

### CROSS-REFERENCE TO RELATED APPLICATIONS

This patent application claims priority under 35 U.S.C. Section 119 to Mexican Patent Application No. MX/a/2024/015525, filed Dec. 13, 2024, the entire disclosure of which is incorporated herein by reference.

### FIELD

The present disclosure relates to the use of new copolymers as corrosion inhibitors in process streams in industrial systems; more specifically, the objective of the disclosure is linked to the use of ionic copolymers with two or three repeating units derived from acrylamide, N-vinylpyrrolidone, vinylimidazolium, and poly(ethylene glycol) methylether methacrylate, which have a random distribution of cationic repeating units and counterions Br⁻, Cl⁻, I⁻, methyl sulfate, and dimethyl sulfate in their chemical structure, making these copolymers active in corrosion inhibition processes. These copolymers show corrosion inhibition at concentrations below 100 ppm and maintain good corrosion inhibition activity up to 60° C.

### BACKGROUND

Many studies on the use of polymers as corrosion inhibitors have been described in scientific literature. Naturally occurring polymers such as starch, cellulose, chitosan, lignin, etc. are considered environmentally friendly and biodegradable, which is why many of these materials have been used to mitigate corrosion. Among these biopolymers, the ones most frequently used as corrosion inhibitors are cellulose and chitosan, including many modifications that can be made to their chemical structures [Mater. Adv. 2 (2021) 3806-3850].

Synthetic polymers used in corrosion mitigation are currently considered a novel field, offering opportunities for the development of these materials as corrosion inhibitors. One of the main advantages of synthetic polymers compared to biopolymers is that they have well-defined chemical structures. In addition, they can have many chemical architectures, such as linear, branched, hyperbranched, cross-linked, and dendritic, with control over the size of their chains. Compared to non-polymeric molecules (organic or inorganic), polymers have advantages in terms of multifunctionality, solubility, flexible viscosity, greater bonding points to metal surfaces, and better film-forming capabilities. The chemical groups that interact with metal surfaces can be anionic, cationic, nonionic, or ampholytic in nature [Int. J. Polym. Sci. 2020 (2020) 1-23].

There are several families of synthetic polymers, both homopolymers and copolymers of two or three repeating units, that have been used in corrosion inhibition. According to their chemical structure, those that have been reported include polyanilines, polyamines, polyimines, polyamides, polyvinylpyridines, polyvinylpyrrolidones, polyvinyl alcohol derivatives, polyacrylic acid derivatives, polyacrylamides, and poly(ionic liquids), among others [Chem. Eng. Commun. 202 (2015) 232-244]. These polymers are functionalized with specific chemical groups to obtain the best corrosion inhibition efficiencies. The chemical structures with which polymers can be modified contain chemical groups consisting mainly of phosphorus, sulfur, and nitrogen [Materials 16 (2023) 2954]. Another class of corrosion inhibitors is based on polymeric nanoparticles or a combination of these with inorganic nanoparticles and are used due to their high surface-to-volume ratio and ability to form self-adhesive protective films on metal surfaces. Inorganic nanomaterials can chemically bond with polymer matrices to form metal complexes and can also be dispersed in polymer matrices.

A study based on a statistical analysis of recent literature classified corrosion inhibitors into six molecule classes: drugs, ionic liquids, surfactants, plant extracts, polymers, and polymeric nanoparticles; these classes were evaluated using carbon steel in a HCl environment, showing some possible guidelines for the development of new molecules for corrosion inhibition. It was observed that polymers are found in a region where high inhibition efficiencies are obtained at low concentrations. Surfactants also have high efficiency, however, concentrations slightly higher than those of polymers are needed, making these two classes of inhibitors the ideal ones for corrosion inhibition of carbon steels. Statistics on behavior versus temperature are also presented. It is important to note that as the temperature in a system rises, corrosion protection decreases due to the increase in the kinetic energy of the molecules and, as a result, there is desorption of the corrosion inhibitors from the metal surface. Surfactants showed the best efficiency compared to other types of inhibitors, with about 9% of them performing adequately at high temperatures (80° C.) [Materials 15 (2022) 2023].

Some polymers that combine two repeating units within their macrochains, such as polyurethane derivatives, PU, polyvinylpyrrolidone (PNVP), and polydimethylaminoethyl methacrylate (PMAEMA) were evaluated as corrosion inhibitors for carbon steel in acidic media (H₂SO₄) at temperatures ranging from 25 to 55° C. and using polymer concentrations from 400 to 1600 ppm. Corrosion inhibition efficiency of up to 97% was obtained at 35° C. and 1600 ppm with the PNPV-PU copolymer, and efficiency increased with the PMAEMA-PU copolymer, reaching up to 99% with 1600 ppm at 25° C. When 55° C. and 1600 ppm were used in the tests, the efficiency decreased to 69% for the PNPV-PU system, and under these same conditions, the PMAEMA-PU system managed to maintain efficiencies as high as 94% [Sci. Rep. 6 (2016) 30937].

Imidazolium-derived poly(ionic liquids) perform well as corrosion inhibitors and are considered non-toxic and environmentally friendly [Corros. Sci. 123 (2017) 256-266]. Poly(1-vinyl-3-imidazolium) propanesulfonate was evaluated as a corrosion inhibitor in acidic HCl solutions, showing up to 93% efficiency at 500 ppm, which was superior to its monomeric counterpart, which achieved 86% efficiency [J. Mol. Liq. 312 (2020) 113436]. Poly(1-vinyl-3-butylvinylimidazolium) bromide was evaluated in acidic HCl solutions and showed 96% efficiency using concentrations of 400 ppm on carbon steel [Colloids Surf. Physicochem. Eng. Asp. 586 (2020) 124195]. Poly(1-acetamido-3-vinylimidazolium bromide, a poly(ionic liquid), was evaluated at 25° C. in an acidic environment (HCl) using carbon steel. Efficiencies of 90% were achieved using 300-ppm concentrations [ChemistrySelect. 6 (2021) 5203-5210].

Another family of anionic poly(ionic liquids) derived from 2-acrylamido-2-propanesulfonic acid monomers, AMPS, either as homopolymers or copolymers with two or more different repeating units, are also drawing attention for their use as corrosion inhibitors. The AMPS homopolymer was quaternized using diethyldiethanolamine, and the results were compared to corrosion inhibition using AMPS homopolymers and AMPS functionalized with diethyldiethanolamine, achieving 85 and 95% efficiency using 250 and 25 ppm, respectively. An acidic environment (HCl) was used, and the evaluations were performed at 25° C. [Int. J. Electrochem. Sci. 10 (2015) 10389-10401]. AMPS was examined with tertiary amines, such as triethanolamine, triethylamine, and trimethylamine to obtain poly(ionic liquids) as corrosion inhibitors of carbon steel in an acidic environment (HCl) at 25° C. The maximal efficiency was obtained with the homopolymer functionalized with triethylamine, reaching 91% with 250 ppm (J. Mol. Struct. 1168 (2018) 106-114).

The following references relate to the protection of inventions involving novel polymer structures.

CN112552508A describes the production and use of polymeric corrosion inhibitors derived from polyethers containing imidazole rings (hydroxyl, amides, or other hydrophilic groups) as side groups with different functionalities to protect carbon steels. Acidic environments (HCl) were used, with concentrations between 70 and 300 ppm. The molecular weight of the polymers was between 600-2400 g/gmol. The polymer concentration in the test solution was between 70 and 300 ppm.

Other polymers used in corrosion inhibition include polyethylene glycol derivatives. This is the case of patent CN113832467A, which describes the use of dopamine-modified polyethylene glycol diacrylate derivatives. The test medium employed aqueous solutions acidified with HCl and NaCl, using polymer concentrations between 10 and 100 ppm and different steels.

CN103469211A claims the preparation and use, for the protection of ferrous materials in the petroleum industry, of polymeric corrosion inhibitors that are homopolymers derived from ionic alkylimidazolines with molecular weights between 2,000 and 6,000 g/gmol and have different alkyl or aryl derivatives and chloride or bromide counterions. The test media were aqueous saline solutions simulating the salinity in oil field floods at 50° C.

U.S. Ser. No. 10/882,771B2 uses polymeric inhibitors derived from polycarboxylic acids, polyhydroxycarboxylic acids, and derivatives of unsaturated phosphonyl monomers, carboxylic acids, or esters with vinyl unsaturations, all containing a phosphonium side group, for use in cooling water systems. The molecular weight was between 1,000 and 10,000 g/mol. The polyhydroxy polycarboxylic acid was selected from the group consisting of saccharic acid, citric acid, tartaric acid, mucic acid, gluconic acid, and combinations thereof. The unsaturated carboxylic acid or ester may be acrylic acid, methacrylic acid, lactic acid, maleic acid, maleic anhydride, or a dicarboxylic acid of itaconic acid, fumaric acid, mesoconic acid, citraconic acid, or tartaric acid, or a monoester of the dicarboxylic acid. The phosphonium groups must contain less than 1.5 ppm of phosphorus in the aqueous solution.

### SUMMARY

This summary is intended to introduce the subject matter of the present disclosure, but does not cover each and every embodiment, combination, or variation that is contemplated and described within the present disclosure. Further embodiments are contemplated and described by the disclosure of the detailed description, drawings (if any), and claims.

The present disclosure provides new corrosion inhibitors based on ionic copolymers that can be used in process streams in industrial systems.

Therefore, one objective of the present disclosure is to provide polymeric chemical compounds with two or three repeating units that can inhibit corrosion in industrial system process streams.

Another objective of the present disclosure is that the inhibitory activity of the ionic copolymers remains effective up to 60° C.

An additional objective of the present disclosure is that the corrosion inhibition of the ionic copolymers occurs at concentrations below 100 ppm.

The foregoing and other objectives of the present disclosure will be set forth more clearly and in detail in the following disclosure.

### DETAILED DESCRIPTION

The present disclosure relates to the use of ionic copolymers of two or three repeating units, which are obtained from the reaction of acrylamide, N-vinylpyrrolidone, poly(ethylene glycol) methyl ether methacrylate, and a vinyl ionic liquid derived from a 1-alkyl-3-vinylimidazolium halide or sulfate. The ionic copolymers have counterions that may comprise chloride (Cl⁻), bromide (Br⁻), iodide (I⁻), methyl sulfate (CH₃SO₃⁻), and ethyl sulfate (CH₃CH₂SO₃⁻). These synthetic ionic copolymers of two or three repeating units can be used to inhibit corrosion in process streams in industrial systems. The copolymers of the present disclosure exhibit anticorrosion activity and can be used in any application where corrosion inhibition is desired.

Monomers derived from the vinyl ionic liquid 1-alkyl-3-vinylimidazolium have the chemical structure shown in Formula (1). When these monomers react with acrylamide or N-vinylpyrrolidone or poly(ethylene glycol) methyl ether methacrylate, copolymers of two or three repeating units are obtained. The poly(ethylene glycol) methyl ether methacrylate monomer has a number average molecular weight, Mn, of 500 g/mol.

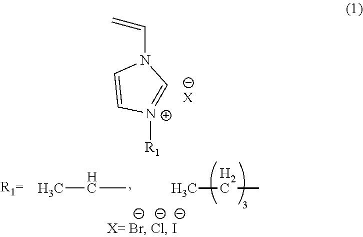

This disclosure also relates to the use of copolymers of two or three repeating units, which are produced by reacting acrylamide, N-vinylpyrrolidone, and 1-vinylimidazole, and which, through a subsequent alkylation reaction with methyl sulfate or diethyl sulfate, can yield ionic copolymers. Formula (2) shows the chemical structures of the monomers from which all polymeric compounds that act as corrosion inhibitors in the present disclosure were obtained.

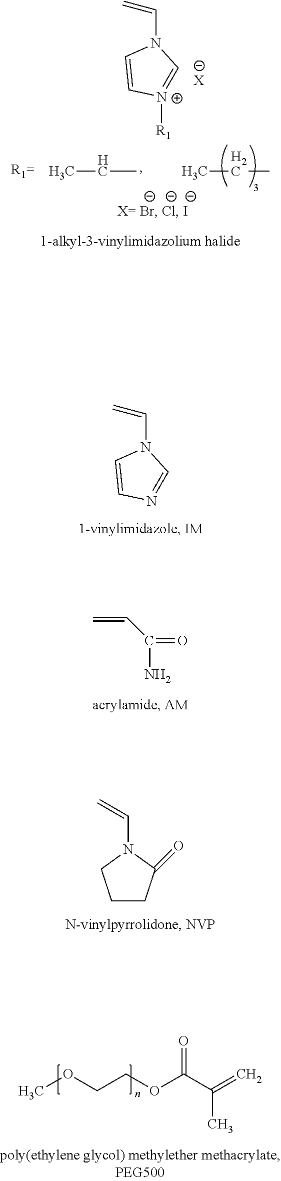

The copolymers of the present disclosure, which consist of two repeating units, function as corrosion inhibitors in process streams in industrial systems at concentrations of less than 100 ppm and temperatures up to 60° C. The copolymers contain units in their chemical structure derived from N-vinylpyrrolidone and a 1-alkyl-3-vinylimidazolium halide (3); poly(ethylene glycol) methyl ether methacrylate and a 1-alkyl-3-vinylimidazolium halide (4); N-vinylpyrrolidone and a 1-alkyl-3-vinylimidazolium sulfate (5); poly(ethylene glycol) methylether methacrylate and a 1-alkyl-3-vinylimidazolium sulfate (6); these repeating units are represented by the following chemical formulas (3), (4), (5), and (6). The copolymer with two repeating units is formed from an initial molar ratio (x, y) of the two monomers in the reaction. The sum of x+y equals 1.

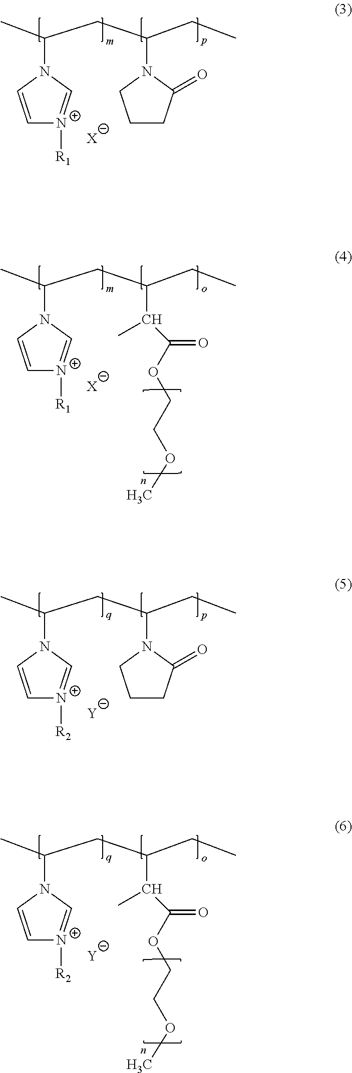

R₁ can be a linear alkyl chain with 2-4 carbon atoms, and X— can be Cl⁻, Br⁻, or I⁻. The letters n, m, o, p, and q correspond to the degree of polymerization of each repeating unit. R₂ may be selected from a linear chain of one or two carbons, and Y may be selected from CH₃SO₃⁻ or CH₃CH₂SO₃⁻.

Copolymers with three repeating units or terpolymers of the present disclosure, which function as corrosion inhibitors in process streams in industrial systems using concentrations of less than 100 ppm and temperatures up to 60° C., have units derived from acrylamide, vinylpyrrolidone, and 1-alkyl-3-vinylimidazolium sulfate (7), acrylamide, vinylpyrrolidone, and 1-alkyl-3-vinylimidazolium halide (8). The copolymer with three repeating units is formed from an initial molar ratio (x, y, z) between the monomers in the reaction. The sum x+y+z equals 1. The initial molar ratio (x,y) comes from the two monomers in the reaction. The sum x+y is equal to 1.

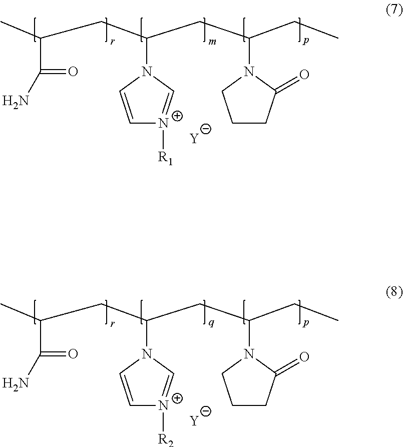

R₁ can be a linear alkyl chain of 2 to 4 carbon atoms and X⁻ can be Cl⁻, Br⁻, or I⁻, and the letters n, m, o, p, q, and r correspond to the degrees of polymerization of each repeating chemical unit. R₂ can be chosen from a linear chain of one or two carbons and Y— can be chosen from CH₃SO₃⁻, CH₃CH₂SO₃⁻.

The present disclosure relates to a process for synthesizing ionic polymers from unsaturated monomers with a vinyl group. These monomers can be polymerized using a free radical mechanism with initiators that may include but are not limited to initiators with peroxides such as benzoyl peroxide, cumene peroxide, 2-terbutylperoxybenzoate, acetyl peroxide, etc., initiators with azo compounds such as azobisisobutyronitrile, 2,2′-diamino-2,2′-azodipropane dihydrochloride, and other initiators such as ammonium persulfate and potassium persulfates, among others. The polymerization techniques that can be used to obtain the copolymers of the present disclosure are bulk polymerization, solution polymerization, emulsion polymerization, etc. In this disclosure, the employed polymerization technique was solution polymerization in a semi-continuous reactor by the free radical mechanism. This is not meant to limit the use of other techniques known in the state of the art of vinyl monomer polymerization.

Copolymerization Reactions with Two Monomers.

Solvents for dissolving monomers in the polymerization reaction of copolymers with two repeating units may include, but are not limited to ethanol, methanol, and water, among others. First, the initial molar ratio (x, y) of the monomers is chosen, which can be between x=0.1 and 0.9, and y=1−x. The two chosen monomers from n-vinylpyrrolidone, 1-vinylimidazole, poly(ethylene glycol) methyl ether methacrylate or 1-alkyl-3-vinylimidazolium bromide are dissolved in the solvent in a reaction flask at a total solid concentration at the start of the reaction between 10-35% mass/volume. The polymerization initiator has concentration relative to the total moles of monomers between 0.005 and 0.1 moles of initiator per total moles of monomers. Once the initial ratio of monomers (x, y) and the total solids percentage have been chosen, the monomers are dissolved in the solvent in the reaction flask and air is removed from this solution by vacuum. After applying vacuum to the reaction system for 15 min, the system is returned to ambient pressure by circulating nitrogen gas. The flow rate of the nitrogen gas is between 0.5 and 5 mL/min, which is maintained throughout the reaction time. Then, the temperature of the reaction solution is increased to 40-60° C. and stirred at 200-400 revolutions per minute (rpm) with magnetic stirrer throughout the reaction time. Next, the initiator solution is prepared at a concentration between 0.01 and 0.5 g/mL, in the same solvent chosen to dissolve the monomers. Air is removed from the solution by vacuum, and it is deposited in a pump to be introduced into the reaction system at a rate of 1 ml/min. The reaction proceeds for 18-24 h. Finally, the reaction system is dismantled, and the copolymer is isolated from the solution by precipitation in acetone. The copolymer is dried at 50-60° C. for 24 h under vacuum. In this way, the copolymer is prepared to be used in the solutions that will be evaluated in corrosion inhibition tests. The molecular weight of the copolymers of the repeating units is in interval ranging from 4,000 to 25,000 g/gmol.

Copolymerization Reactions with 3 Monomers.

The development of the copolymerization reaction from three monomers is the same as the methodology followed to obtain copolymers with 2 monomers. The difference lies in the determination of the molar ratios (x, y, z) of the three monomers in the initial solution of acrylamide (AM), vinylpyrrolidone (NVP), and 1-alkyl-3-vinylimidazolium halides (HVIM). Assuming that the monomers are (AM-NVP-HVIM) and their initial molar ratios are (x, y, z), respectively, then it is considered that z can vary from 0.2 to 0.4 mol, and from 0.2 to 0.4, and x=100−y−z, for each particular composition of a terpolymer: (AM-VP-VIM) (x,y,z). It must be true that x+y+z=1.

When the 1-vinylimidazole (VIM) monomer is used in conjunction with acrylamide (AM) and vinylpyrrolidone (NVP), nonionic copolymers with three repeating units are obtained. The methodology for developing the copolymerization reaction from these three monomers is the same as that used to obtain the copolymers with the three previous monomers. The difference is that these nonionic copolymers will be alkylated with methyl and ethyl sulfate to obtain the respective ionic copolymers 1-methyl-3-vinylimidazolium dimethyl sulfate and 1-ethyl-3-vinylimidazolium diethyl sulfate, respectively. The molecular weight of the copolymers of the repeating units is in the interval ranging from 4,000 to 30,000 g/mol.

Alkylation of Nonionic Copolymers with Dimethyl Sulfate and Diethyl Sulfate.

The procedure followed for the alkylation of copolymers with two or three repeating units was to use dimethyl sulfate or diethyl sulfate. The alkylation reaction was carried out by dissolving the copolymer with two or three repeating units, one of which is 1-vinylimidazole, in water at a concentration between 10 and 60%, maintaining constant stirring at 200 and 400 rpm. Under ambient conditions, a molar amount of dimethyl sulfate or diethyl sulfate equivalent to the moles of the 1-vinylimidazole repeating unit is added. The reaction is allowed to continue under ambient temperature and pressure conditions for 3 h. The copolymer is separated from the reaction mixture by precipitation in acetone. The copolymer is dried at 50-60° C. for 24 h under vacuum. In this way, the copolymers of 2 or 3 repeating units are prepared to be used in the solutions that will be evaluated in corrosion inhibition tests.

### Evaluation of Copolymers as Corrosion Inhibitors

The evaluation of the copolymers as corrosion inhibitors was carried out by gravimetric tests using congenital water from a storage facility. The composition of these compounds is shown in Table 1.

The % efficiency was calculated using Equation 1 and the corrosion rate in thousandths of an inch per year (mpy) was obtained using Equation 2:

$$Efficiency ( \% ) = \frac{Reference weight loss ( mg ) - Product weight loss ( mg )}{Reference weight loss} \qquad ( Eq . 1 )$$

$$\begin{matrix}Corrosion rate ( mpy ) = rX \frac{Weight lossP ( mg )}{( δ metal ) X ( A ) X ( T )} \\ where conversion factor , r = 2459.43 , δ = metal density ( g / {cm}^{3} ) , A = corrosion specimen area ( {cm}^{2} ) , T = exposure time ( h ) .\end{matrix} \qquad ( Eq . 2 )$$

TABLE 1
Composition of congenital water for corrosion inhibition testing.

| No. | Species | Composition, mg/L |
|---|---|---|
| 1 | Chlorides | 27200 |
| 2 | Chemical Oxygen Demand | 92 |
| 3 | Total Hardness | 2770 |
| 4 | Fat and Oils | 89.4 |
| 5 | Total Suspended Solids | 58 |
| 6 | Settleable Solids | <0.1 |
| 7 | Sulfides | 4 |

Corrosion inhibition tests were performed using congenital waters with the compositions shown in Table 1, in 10-mL cells at a constant temperature of 40±1° C. and dosage of copolymers acting as corrosion inhibitors of 5, 20, and 100 ppm. Brines were also used in accordance with NACE 1 D182-2017-SG (wheel test method used for the evaluation of persistent film corrosion inhibitors for oilfield applications), which have the following compositions: 9.62% NaCl, 0.305% CaCl₂), 0.186 percent MgCl₂·6H2O, and 89.89% distilled water. Concentrated acetic acid is then added until pH of 3.5 is reached. Subsequently, N₂ is bubbled for 30 min to displace dissolved 02, and finally, sodium sulfite (Na₂SO₃, 4 mg/L) is added to sequester the traces of oxygen. Sulfhydration is achieved by introducing a stream of H₂S generated from the reaction of commercial iron sulfide (FeS) and muriatic acid (HCl).

Corrosion inhibition was evaluated on SAE 1010 carbon steel alloys (1×0.5×0.010 inches) and Admiralty CDA443 test pieces (3×⅜×⅙ inches) over a test period of 7 days. The preparation and cleaning of the test specimens was carried out following the ASTM G1-21 method. Table 2 shows the chemical composition of the two alloys. Two corrosive media were used, characterized as sour (H₂S) and sweet (CO₂) media, respectively, as defined by NACE-1 D-182 standards.

The copolymers of the present disclosure are useful for controlling internal corrosion in petroleum refining streams, in which the associated water content has a concentration of inorganic salts (i.e. chlorides, sulfates, and carbonates, among others) ranging from 300 to 7,800 ppm and where H₂S and/or CO₂ are present as dissolved gases.

TABLE 2
Chemical composition of the alloys
used in the corrosion evaluation.

Content (% weight)

| | SAE 1010 | Admiralty |
|---|---|---|
| Element | Carbon Steel | CDA443 |
| Carbon (C) | 0.8-0.13 | — |
| Manganese (Mn) | 0.30-0.60 | — |
| Phosphorus (P) | 0.04 máx. | — |
| Sulfur (S) | 0.05 máx. | |
| Cooper (Cu) | — | 70.00 |
| Tin (Sn) | — | 1.00 |
| Zinc (Zn) | — | 29.00 |

### EXAMPLES

The present disclosure and its features have been described. The following examples are provided for illustrative purposes and are not intended to limit the scope of the disclosure.

### Example 1

### Preparation of poly(n-vinylpyrrolidone-1-butyl-3-vinylimidazole) bromide Copolymer

In a reaction flask equipped with a thermometer, a condenser, and a magnetic stirrer, an aqueous solution with 10 g of N-butyl-N-vinylimidazolium bromide (0.043 moles) and 4.8 g of 1-vinylpyrrolidone (0.043 moles) in 80 mL of water, corresponding to a total concentration of 18.5% solids in the reaction solution, was prepared. With this amount of moles, the (n-vinylpyrrolidone-1-butyl-3-vinylimidazole) bromide copolymer has an initial molar ratio (x, y) of (0.5, 0.5). Air was removed from the solution under vacuum for 15 min while stirring at 200 rpm. The solution was returned to ambient pressure by circulating nitrogen gas into it at a rate of 0.5 ml/min, which was maintained throughout the reaction time. Once the temperature of the reaction solution reached 50° C., the V50 initiator was pumped into the reaction flask at a rate of 1 ml/min. The initiator had a concentration relative to the monomers of 0.014 moles of initiator per mole of monomer. The reaction was allowed to continue for 20 h. Afterward, the system was dismantled, and the copolymer was recovered by precipitating the reaction solution in acetone. The copolymer was dried at 60° C. for 24 h under vacuum. In this way, the copolymer was prepared to be used in the solutions that will be evaluated in corrosion inhibition tests. The molecular weight was 20.540 g/mol.

### Example 2

### Preparation of poly(1-butyl-3-vinylimidazolium-PEG500) bromide Copolymer

In a reaction flask equipped with a thermometer, a condenser, and a magnetic stirrer, an aqueous solution was prepared with 14.4 g of 1-butyl-3-vinylimidazolium bromide (0.062 moles) and 7.82 g of PEG500 (0.015 moles) in 100 mL of water, corresponding to a total concentration of 22.3% solids in the reaction solution. With this amount of moles, the (1-butyl-3-vinylimidazolium-PEG500) bromide copolymer had an initial molar ratio (x, y) of (0.8, 0.2), respectively. Once the temperature of the reaction solution reached 50° C., the V50 initiator was pumped into the reaction flask at a rate of 1 ml/min. The initiator had a concentration relative to the monomers of 0.028 moles of initiator per mole of monomer. Following the procedure in EXAMPLE 1, the copolymerization reaction of (1-butyl-3-vinylimidazolium-PEG500) bromide was carried out. The molecular weight was 25,260 g/mol.

### Example 3

### Preparation of the poly(acrylamide-n-vinylpyrrolidone-1-vinylimidazole) Copolymer

In a reaction flask equipped with a thermometer, a condenser, and a magnetic stirrer, an aqueous solution was prepared with 4.32 g of 1-vinylimidazole (0.046 moles), 6.0 g of NVP (0.054 moles), and 3.83 g of acrylamide (0.054 moles) in 100 mL of water, corresponding to a total monomer concentration of 14.15% solids in the reaction solution. According to the molar quantities, the poly(acrylamide-n-vinylpyrrolidone-1-vinylimidazole) copolymer had a molar ratio (x, y, z) of (0.35, 0.35, 0.30). V50 initiator was pumped into the reaction flask at a rate of 1 ml/min. The initiator had a concentration with respect to the monomers of 0.014 moles of initiator per mole of monomer. Following the procedure in EXAMPLE 1, the copolymerization reaction of poly(acrylamide-n-vinylpyrrolidone-1-vinylimidazole) was carried out.

### Example 4

### Preparation of poly(acrylamide-n-vinylpyrrolidone-1-methyl-3-vinylimidazolium) methyl sulfate Copolymer

The preparation of the poly(acrylamide-n-vinylpyrrolidone-1-methyl-3-vinylimidazole) methyl sulfate copolymer was carried out using the nonionic copolymer from EXAMPLE 3, the poly(acrylamide-n-vinylpyrrolidone-1-vinylimidazole) copolymer having a molar ratio (x, y, z) of (0.35, 0.35, 0.30). 1.28 g of poly(acrylamide-n-vinylpyrrolidone-1-vinylimidazole) were weighed, which corresponded to 0.0048 moles of the VIM repeating unit, and dissolved in 10 mL of water (concentration of 12.8%). Once the copolymer was dissolved in water, 0.45 g of dimethyl sulfate (0.0048 moles) were added at room temperature. The reaction was allowed to proceed at ambient temperature and pressure for 3 h. The copolymer was separated from the reaction mixture by precipitation in acetone. The copolymer was dried at 50-60° C. for 24 h under vacuum. The poly(acrylamide-n-vinylpyrrolidone-1-methyl-3-vinylimidazolium) methyl sulfate copolymer was thus prepared. The molecular weight was 15,350 g/mol.

### Examples 5-7

### Performance of the poly(acrylamide-n-vinylpyrrolidone-1-methyl-3-vinylimidazol) methyl sulfate Corrosion Inhibitor (0.35, 0.35, 0.30) in SAE 1010 Carbon Steel

The test was carried out under immersion conditions for 7 days at a constant temperature of 40° C. in congenital waters with concentrations described in

TABLE 1
The preparation and cleaning of the control
were carried out in accordance with ASTM G1.

| | Inhibitor | Corrosion | |
|---|---|---|---|
| Example | concentration, ppm | rate, mpy | Efficiency, % |
| 5 | 5 | 3.4 | 47.1 |
| 6 | 20 | 2.7 | 57.5 |
| 7 | 100 | 2.3 | 64.7 |

### Examples 8-10

### Performance of poly(acrylamide-n-vinylpyrrolidone-1-methyl-3-vinylimidazole) methyl sulfate Corrosion Inhibitor (0.35, 0.35, 0.30) in Admiralty CDA443

The corrosion test conditions for these examples were the same as those in EXAMPLES 5-7.

| | Inhibitor | Corrosion | |
|---|---|---|---|
| Example | concentration, ppm | rate, mpy | Efficiency, % |
| 8 | 5 | 1.0 | 61.1 |
| 9 | 20 | 0.6 | 78.4 |
| 10 | 100 | 0.4 | 82.6 |

### Examples 11-13

### Performance of poly(acrylamide-n-vinylpyrrolidone-1-methyl-3-vinylimidazole) ethyl sulfate Corrosion Inhibitor (0.35, 0.35, 0.30) in SAE 1010 Carbon Steel

The corrosion test conditions for these examples were the same as those in EXAMPLES 5-7.

| | Inhibitor | Corrosion | |
|---|---|---|---|
| Example | concentration, ppm | rate, mpy | Efficiency, % |
| 11 | 5 | 2.3 | 64.1 |
| 12 | 20 | 2.0 | 68.6 |
| 13 | 100 | 2.5 | 61.4 |

### Examples 14-16

### Performance of poly(acrylamide-n-vinylpyrrolidone-1-methyl-3-vinylimidazole) ethyl sulfate Corrosion Inhibitor (0.35, 0.35, 0.30) in Admiralty CDA443

The corrosion test conditions for these examples were the same as those in EXAMPLES 5-7.

| | Inhibitor | Corrosion | |
|---|---|---|---|
| Example | concentration, ppm | rate, mpy | Efficiency, % |
| 14 | 5 | 0.6 | 78.4 |
| 15 | 20 | 0.6 | 75.4 |
| 16 | 100 | 0.4 | 77.2 |

### Examples 17-19

### Performance of poly(n-vinylpyrrolidone-1-butyl-3-vinylimidazole) (0.5, 0.5) Corrosion Inhibitor in SAE 1010 Carbon Steel

The corrosion test conditions for these examples were the same as those in EXAMPLES 5-7.

| | Inhibitor | Corrosion | |
|---|---|---|---|
| Example | concentration, ppm | rate, mpy | Efficiency, % |
| 17 | 5 | 2.9 | 54.2 |
| 18 | 20 | 2.9 | 54.2 |
| 19 | 100 | 2.7 | 57.5 |

### Examples 20-22

### Performance of poly(n-vinylpyrrolidone-1-butyl-3-vinylimidazole) (0.5, 0.5) Corrosion Inhibitor in Admiralty CDA443

The corrosion test conditions for these examples were the same as those in EXAMPLES 5-7.

| | Inhibitor | Corrosion | |
|---|---|---|---|
| Example | concentration, ppm | rate, mpy | Efficiency, % |
| 20 | 5 | 0.5 | 82.0 |
| 21 | 20 | 0.5 | 82.0 |
| 22 | 100 | 0.5 | 81.4 |

What is claimed is:

1. An ionic copolymer comprising two repeating units in a polymer chain, wherein the repeating units comprise a composition having a chemical structure of a chemical formula selected from the group consisting of Formula (3), Formula (4), Formula (5), and Formula (6): 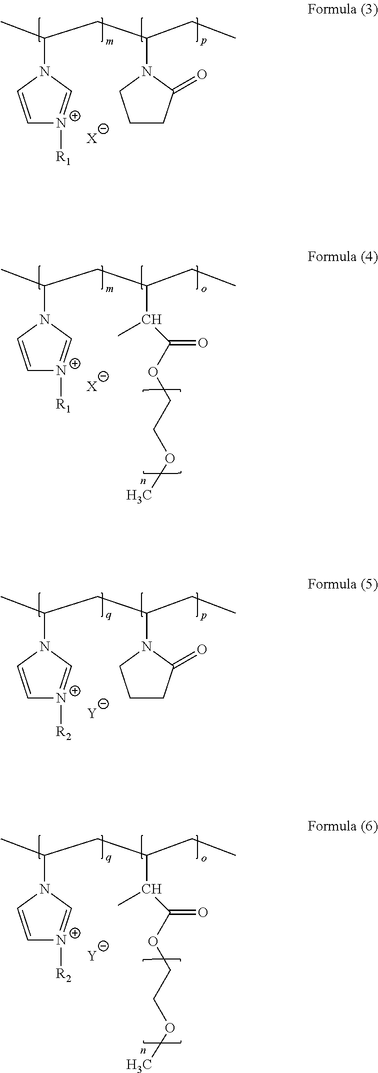
wherein:
R1 is selected from a linear alkyl chain of 2 to 4 carbon atoms and X⁻ is selected from Cl⁻, Br⁻, or I⁻, and the letters n, m, o, p, and q correspond to degrees of polymerization of each repeating unit;
R₂ is selected from a linear chain of 1 or 2 carbon atoms and Y⁻ is selected from CH₃SO₃⁻ or CH₃CH₂SO₃⁻; and
the two repeating units have an initial molar ratio (x, y) between the monomers, wherein x is between x=0.1 and 0.9, and wherein y is y=1−x and x+y is equal to one, and
wherein the ionic copolymer functions as a corrosion inhibitor for metals and their alloys in process streams in industrial systems.

2. A method of inhibiting corrosion in process streams in industrial systems, the method comprising:
using a copolymer according to claim 1 to inhibit corrosion of metals and their alloys in process streams in an industrial system at concentrations below 100 ppm and at a temperature of up to 60° C.

3. A method of inhibiting corrosion in process streams in industrial systems, the method comprising:
using a copolymer according to claim 1 to inhibit corrosion of metals and their alloys in process streams in an industrial system in corrosive media comprising congenital water from oil extraction or synthetic brines.

4. An ionic terpolymer comprising three repeating units in a polymer chain, wherein the repeating units comprise a composition having a chemical structure of a chemical formula selected from the group consisting of Formula (7) and Formula (8): 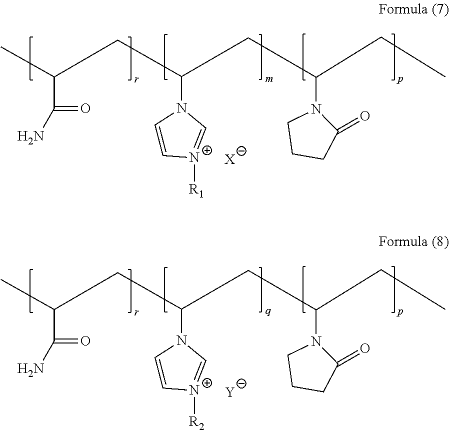
wherein:
R₁ is selected from a linear alkyl chain of 2 to 4 carbon atoms and X⁻ is selected from Cl⁻, Br⁻, or I⁻, and the letters n, m, o, p, q, and r correspond to degrees of polymerization of each repeating unit; and
R₂ is selected from a linear chain of 1 or 2 carbon atoms and Y⁻ is selected from CH₃SO₃⁻ or CH₃CH₂SO₃, and initial molar ratios are (x, y, z) respectively, where z is considered to vary from 0.2 to 0.4, and from 0.2 to 0.4, and x=100−y−z, and where the sum of the molar ratios x+y+z=1, and
wherein the ionic terpolymer functions as a corrosion inhibitor for metals and their alloys in process streams in industrial systems.

5. A method of inhibiting corrosion in process streams in industrial systems, the method comprising:
using a terpolymer according to claim 4 to inhibit corrosion of metals and their alloys in process streams in an industrial system at concentrations below 100 ppm and at a temperature of up to 60° C.

6. A method of inhibiting corrosion in process streams in industrial systems, the method comprising:
using a terpolymer according to claim 4 to inhibit corrosion of metals and their alloys in process streams in an industrial system in corrosive media comprising congenital water from oil extraction or synthetic brines.
